(19) United States
(12) Patent Application Publication
(10) Pub. No.: US 2025/0321355 A1
(43) Pub. Date: Oct. 16, 2025

(54) SYSTEM AND METHOD FOR MONITORING ENVIRONMENTAL EVENTS

(71) Applicant: ICEYE OY, Espoo (FI)

(72) Inventors: Shay Strong, Espoo (FI); Johannes Hiekkasaari, Espoo (FI); Uyen Truong, Espoo (FI); Samuel Thompson, Espoo (FI)

(73) Assignee: ICEYE OY, Espoo (FI)

(21) Appl. No.: 18/866,179

(22) PCT Filed: May 25, 2023
(86) PCT No.: PCT/EP2023/064041

§ 371 Date: Nov. 15, 2024

(30) Foreign Application Priority Data
May 30, 2022 (GB) 2207993.3

(51) Int. Cl. G01W 1/14; G01S 13/90; G01S 13/95; G06F 16/29; G06Q 50/00; G06V 10/75; G06V 20/10; G06V 20/13

(52) U.S. Cl. CPC G01W 1/14; G01S 13/90; G01S 13/95; G06F 16/29; G06Q 50/01; G06V 10/751; G06V 20/13; G06V 20/176

(57) ABSTRACT

One or more environmental events on earth are monitored by a method comprising receiving a notification of an environmental event occurring, wherein the notification is derived from first environmental data. An area on Earth corresponding to the notification is identified. A determination is made that the event meets one or more predetermined event criteria and in response to the determination the event is monitored by collecting additional environmental data. Additional environmental data determined to be relevant to the event according to one or more relevance criteria is tagged to the event in a geographically indexed database and used to estimate the severity of the event at locations within the identified area.

### BACKGROUND

Environmental events include can include adverse events such as floods, firestorms, duststorms, hurricanes, tornadoes, volcanic eruptions, earthquakes, tsunamis, storms, and others. These environmental events have the potential to cause significant loss of life or property damage. In these types of large-scale events, it can be difficult to know the extent and severity of the damage caused by the environmental event, especially during the event when the situation can be very dynamic, and also immediately after the event when infrastructure and communication systems may have been destroyed. The invention is not limited to adverse events may also be used for the monitoring of other kinds of environmental event.

A solution is required in order to be able to more quickly and accurately react to and monitor an environment event. U.S. Pat. No. 10,346,446B2 discloses a system and method for aggregating multi-source data and identifying geographic areas for data acquisition. Here, asynchronous data packets, such as may be obtained from social media postings, weather conditions at a weather location, newswire stories, and Open Street Maps (OSM) maps, are identified as worthy of consideration and correlated with “first time change” information such as may be obtained using satellite imagery. The result of the correlation is then used to direct resources, for example to predict a geographic progression of a correlated event.

The invention is not limited to solutions to any problems described here and may solve other problems.

### SUMMARY

This summary is provided to introduce a selection of concepts in a simplified form that are further described below in the detailed description. This summary is not intended to identify key features or essential features of the claimed subject matter, nor is it intended to be used to determine the scope of the claimed subject matter.

Some of the systems and methods described in the following are concerned with estimating the local severity of environmental events, for example in near real time.

In some of the systems and methods described in the following, a notification is received of an environmental event derived from first environmental data. An area on Earth corresponding to the notification is identified. A determination is made that the event meets one or more predetermined event criteria and in response to the determination, the event is monitored by collecting additional environmental data. Additional environmental data determined to be relevant to the event according to one or more relevance criteria is tagged to the event in a geographically indexed database and used to estimate the severity of the event at locations within the identified area.

### BRIEF DESCRIPTION OF THE DRAWINGS

Embodiments of the invention will be described, by way of example only and with reference to the following drawings, in which:

FIG. 1 is a flowchart illustrating a method of monitoring environmental events;

FIG. 2 is a schematic diagram illustrating a possible architecture of a system for monitoring environmental events;

FIG. 3 is a schematic diagram of a process that may be implemented to allow automated ingestion and use of environmental data from back end servers;

FIG. 4 is a schematic diagram showing a method of flood monitoring;

FIG. 5 is an image a flooded area showing severity of flooding of individual buildings;

FIG. 6 is an image of a flooded area showing severity of flooding of individual buildings;

FIG. 7 is a schematic diagram illustrating how additional data may be processed;

FIG. 8 shows an example of a precipitation timeline;

FIG. 9 is a series of photos showing how they may be geo-located;

FIG. 10 shows how severity of a flood may be determined using on-the-ground photographic information;

FIG. 11 is a two dimensional image of a flood showing how the extent of an event may be determined;

FIG. 12 is a schematic diagram showing the use of multiple processes to create an accurate flood model;

FIG. 13 is a schematic diagram showing monitoring of wildfires;

FIG. 14 is a block diagram of an exemplary computing system which any of the systems and methods described here may be implemented.

Common reference numerals are used throughout the figures to indicate similar features.

### DETAILED DESCRIPTION

Embodiments of the present invention are described below by way of example only. These examples represent the best ways of putting the invention into practice that are currently known to the applicant although they are not the only ways in which this could be achieved.

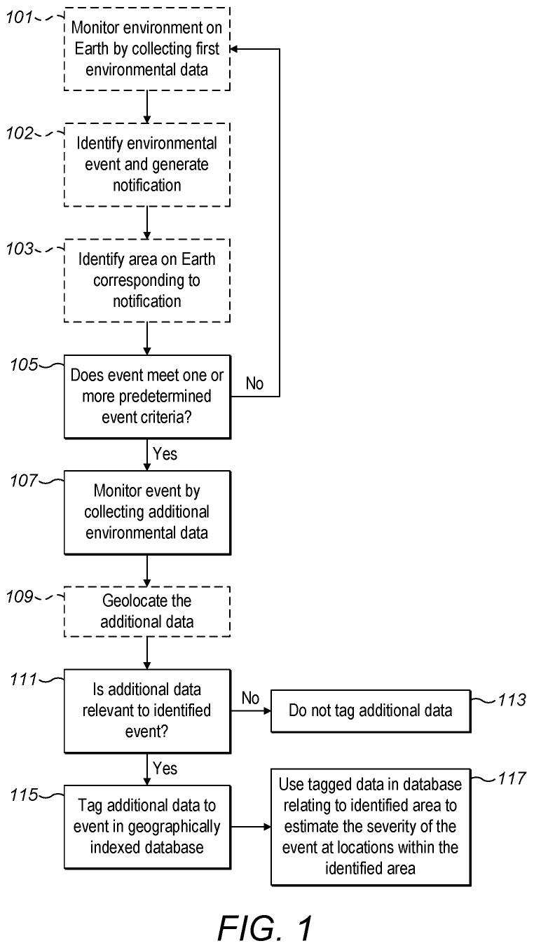

FIG. 1 is a flowchart showing a method of monitoring environmental events that may be applied to many different kinds of events. Some specific examples of implementations of the method will be further described with reference to the subsequent figures.

The systems and methods described here may be used to monitor any kind of environmental event as is known to those skilled in the art. Examples of events include but are not limited to earthquakes, forest fires, floods and tornados. These are events that may be termed catastrophic. Other environmental events that may be monitored according to the methods described here include, for example, large changes in environmental data such as a large rise or drop in the depth of a river, a large increase or decrease in temperature, any of which may for example be precursors to a catastrophic event.

It will be appreciated that a system for monitoring environmental events, for example to implement the method illustrated in FIG. 1 may comprise a computing system, which will typically comprise a distributed computing system using computing power in different locations. Some implementations may benefit from use of cloud-based systems, discussed further below.

In FIG. 1, optional operations or operations are shown in dotted line boxes. Thus a first operation in the method may be to receive a notification of an event and determine at operation 105 whether the event meets predetermined event criteria described further below. The notification may have been received from a remote source, for example operated by a third party. The notification may identify the geographical location of the event.

Additionally or alternatively to the use of third party notifications, the method may include monitoring the environment on Earth at operation 101 by collecting first environmental data. The first environmental data be obtained from third party sources. Additionally or alternatively a system as described here may include sensors and other apparatus for collecting the first environmental data.

At operation 102, an environmental event may be identified from the first environmental data and a notification of the event may be generated.

At operation 103, an area on Earth corresponding to the notification may be identified. The notification, whether from third party sources or within the system described here, may include information relating to an area on Earth corresponding to the notification, and this may be used to identify the area at operation 103. Additionally or alternatively, it may be necessary to obtain additional data, for example corroborating information, in order to identify the area at operation 103. The area identified at operation 103 may be termed an area of interest “AOI”.

The identifying of the area at operation 103 may comprise identifying an area likely to be affected by the event. For example, the notification may identify a specific geographical location. From this it may be desirable to obtain data relating to an area larger than the location, optionally depending on the nature of the event. It may be useful to redefine the area from time to time as the monitoring process described here proceeds.

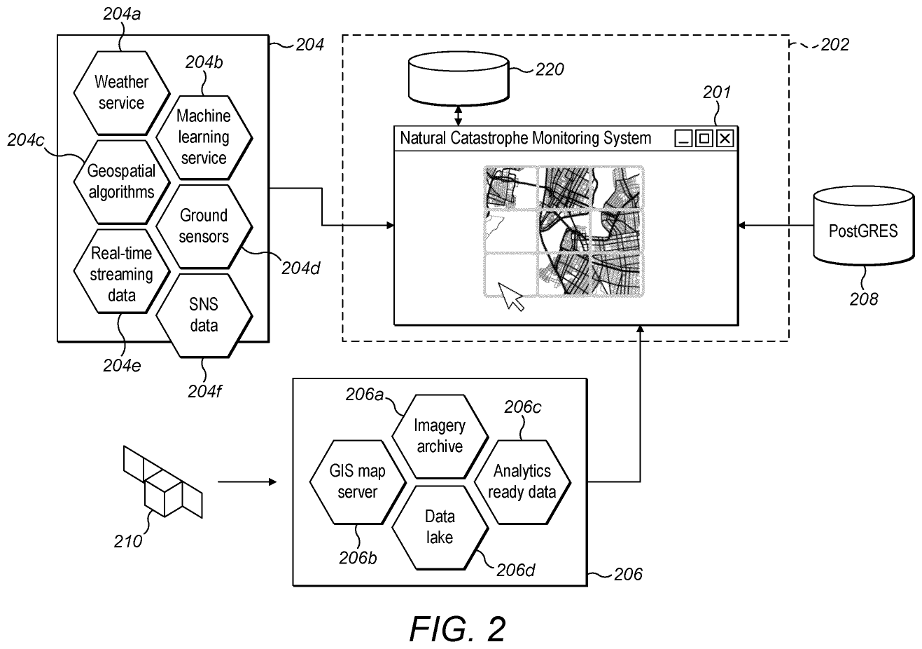

Thus determination at operation 105 may be implemented in a computing module such as a decision engine, described further with reference to FIG. 2, receiving inputs from remote sources and/or sources which are part of the system.

The monitoring taking place at operation 101 may be representative of a normal or background mode of operation when the environment in general, as opposed to any specific environmental event, is being monitored.

The term “environmental data” is intended to be broadly construed and may include meteorological data such as temperature, humidity, rainfall and wind speeds, and other data obtained for example from sensors and/or measuring instruments. It may include image and radar data, for example from one or more satellites or other platforms above Earth such as airplanes and other airborne platforms. Environmental data may include data from sources other than sensors such as social media reports in text, image or other forms. From this it will be appreciated that in some methods one or more pre-filtering operations may be performed on received notifications to determine whether they contain sufficient information for a decision at operation 105 to be made. Additionally or alternatively similar filtering may be applied at operation 102 where the event is identified and notified.

The foregoing are examples of data that might be generated and/or monitored relatively frequently, for example at least daily.

Environmental data also includes data that is generated less frequently and may not be monitored but is also useful as part of the methods described here. Such data includes but is not limited to map data, such as open source maps, Google maps, and other sources of map or geographical information; structural information for example relating to buildings, roads and other man-made structures, modelling information such as flood prediction models, information on soil permittivity, coverage by crops or other vegetation, height above nearest drainage, and other recorded information. This kind of data may be useful in identifying the area corresponding to the notification, and hence corresponding to the event. Some of this may be termed “historical” or non-real-time data.

The following are examples of predetermined event criteria that may be applied at operation 105. Others will occur to those skilled in the art and may be applied in any of the methods described here.

The predetermined event criteria may include geographical criteria. Thus a method as described here may be limited to one or more geographical regions.

The predetermined event criteria may include a global severity threshold. This is distinct from the local severity of the event discussed with reference to operation 117. The global severity may be determined in different ways depending on the nature of the event. Examples of global severity include but are not limited to geographical extent, e.g. area, and number of population affected or likely to be affected.

In some methods the received notifications may be processed in different channels for example according to the nature of the event being notified, or the format in which the notification is received, or other categories.

If the event does not meet the one or more predetermined criteria at operation 105, the process of monitoring at operation 101 may continue. If the event does meet the one or more predetermined criteria, the process continues to operation 107 where additional environmental data is collected. The purpose of operation 107 is to collect additional data relating to the event. The event may be said to be “activated” in response to it meeting the one or more predetermined criteria and a second mode of operation may commence.

It should be noted here that the collection of first environmental data at operation 101 may continue after a first event has been activated, that is a first event satisfies operation 105. Thus multiple events may be activated in parallel. The following operations of FIG. 1 are described in relation to a single event for simplicity.

The collection of additional data may differ from the collection of first data in one or more ways. In other words the collection of the first data may be according to first data collection criteria and the collection of the additional data may be according to second data collection criteria. A number of examples are described here and others will occur to those skilled in the art.

The collection of additional data may comprise collecting the same data as at operation 101 at a higher frequency in order to obtain more of this data and to more closely monitor the progress of the event. The collection of additional data may also comprise collecting higher resolution or higher-quality versions of the same data.

The collection of additional data may comprise collecting data from additional sources that are not providing the first data.

Broad criteria may be defined for the collection of the additional data and may depend on the source.

Whether or not the additional data comprises the same data or data from sources not comprised in the first data, the result of collecting the additional data is that data relating to the event is collected more frequently than was occurring prior to operation 105.

The criteria for the collection of additional data could for example include one or both of one or more keywords and geographical criteria. Thus the additional data could include data that is geo-located within or within a predetermined range of the identified area or location of the event. It could also be collected based on searches by keywords, for example. In the example of a flood, the data might include news reports and other social media items that are found by keyword searching (e.g., on “flood” and “[location]”). The additional data could include data from sources that are outside the identified area (e.g., weather reports from areas in which the weather systems are coming from).

The additional data may not comprise any associated location information in which case it may be geolocated, or “tagged” with the location to which it relates at operation 109. Examples of how this might be done are described further below.

At operation 111 the additional data is examined to determine whether it is relevant to the identified event according to one or more relevance criteria. The relevance criteria may comprise whether the data relates to a location within a predetermined range of the identified area, since the collection criteria may include data that is not already geolocated. Other relevance criteria may include geolocation for data that is geolocated, presence of keywords, and others. The relevance criteria may depend on the nature of the additional data and/or the nature of the event. For example in the case of image data a criterion may be whether the event is apparent in the image, which may for example be determined using image processing techniques. A specific example is a traffic camera which might be in the correct geolocation but pointing too high to be able to see flooding on the ground. However it might capture useful information relating to a wildfire.

The general principle of applying the relevance decision at operation 111 is to enable broad collection of additional data at operation 107 that is then filtered at operation 111. This also may be implemented in a decision engine described further with reference to FIG. 2.

Data that satisfies the relevance criteria is tagged to the event in a geographically indexed database at operation 117. Data that does not satisfy the relevance criteria is either discarded or not tagged and retained in the database for future use at operation 113.

At operation 117 the tagged data in the database relating to the event is used to estimate the severity of the event at locations within the identified area. By determining the severity, more information may be obtained relating to the event than simply determining the extent of the event, which may only indicate whether a building or area was impacted by the event or not. In particular, the severity may indicate not only whether a location was impacted but also to what degree it was impacted.

As noted elsewhere here, for a flood the severity may be determined by the estimated depth of the flood at a particular location, optionally at high resolution, for example at individual buildings. For flooding and other kinds of environmental event the local severity within the overall extent or identified area may be estimated in other various ways. For example, a lower resolution measure of severity could be whether a number or percentage of buildings still standing or washed away or otherwise damaged. In the case of natural features, measure of severity could be for example the percentage of land or crops that have been washed away, which might be appropriate for floods, landslides, snowstorms and other events.

The severity is determined at operation 117 for locations within the area identified at operation 103. The locations may be landmarks, buildings or other features within the identified area. Additionally or alternatively, for the monitoring of some environmental events the area identified at operation 103 may be subdivided in order to determine the severity at operation 117. Therefore the locations may comprise areas within the identified area. A geometrical pattern such as a square or hexagonal grid may be used for the subdivision. Alternatively the area may be more conveniently subdivided using geographical features, for example using a river to divide one area from an adjacent area. It will be appreciated that the type of subdivision may depend on the event being monitored. For complete monitoring of the identified area the sub-areas, i.e. the areas within the identified areas, may be contiguous.

It follows from the foregoing that other possible measures of severity include but are not limited to percentage or degree of area that is burnt, degree of damage suffered by buildings, infrastructure, vegetation or other features (e.g,. untouched, partially burnt, burnt to the ground), particularly appropriate to wildfires and other events that result in fires; for volcanic activity percentage coverage by lava and/or depth of coverage, percentage of buildings that are still standing; for earthquakes: percentage of buildings and other infrastructure that have been damaged, and extent of damage (no change, some shifting in the buildings, full collapse, etc.).

FIG. 1 illustrates a method in which two modes of collection of environmental data are envisaged. First data is collected at operation 101 in a “normal” or background mode and additional data is collected in an “event actuated” mode in response to activation of an event. Additional modes of collection are possible, for example to be implemented before an event is “activated”. For example an additional mode may be useful to determine the location of an event associated with a notification received at operation 105. For example a social media report of a flood may be received with no indication of its location in which case an intermediate mode may be implemented to “listen” for corroborating information which can be used to locate the event. These modes of operation are not mutually exclusive and they may be implemented in parallel for example.

All of the monitoring described here may be done in real time as an event progresses. However information acquired by real-time monitoring may be augmented with historical data, also referred to here as non-real time data.

By monitoring and determining the severity of an event at locations within a larger area the methods and systems described here can be used for example to obtain an immediate assessment of damage sustained during an environmental event so that resources, such as emergency assistance or later repair work, can be correctly directed within the identified area, for example the area affected by the event.

Some of the systems and methods use synthetic aperture radar “SAR” data acquired from space or airborne platforms, together with geo-located data from one or more sources on Earth. Thus for example the notification may be generated at operation 102 from SAR data. In the case of a flood or forest fire for example, the SAR data may enable the determination of the geographical extent of the environmental event. The area identified at operation 103 may be larger than the extent discernible from the SAR data to include areas likely to be affected by the event.

The area identified at operation 103 may be contiguous but this is not necessarily the case. In other words more than one area on Earth may be identified at operation 103. For example if the environmental event is a flood, areas identified at operation 103 may be separated by areas of high ground that are not likely to be affected by the flood.

FIG. 2 is a schematic diagram illustrating a possible architecture of a system for monitoring environmental events. This is an example of an architecture that may enable and implement the operations of FIG. 1, in particular operations 107-117 which may be continuously repeated on an ongoing basis during the course of an environmental event such as a natural catastrophe.

The system of FIG. 2 comprises a web application map-based front end 201, which may be implemented on any computer or computing system for example, which may be configured as a server, indicated by box 202. This may comprise a geographically indexed database 220 as described with reference to FIG. 1 containing tagged data relating to notified events. The front-end server 202 may perform many functions including implementing a decision engine to make decisions at operations 105 and 111 as mentioned in connection with FIG. 1. The decision engine implemented in server 202 may receive inputs from back end servers indicated by box 204, which may be third party servers, and ground based servers 206 which may form part of a system as described here.

In general, inputs to the front end from weather services and ground sensors and other sources can help to predict environmental events and to identify affected areas. Geospatial algorithms can be used for example to combine geospatial data into a common format that can be stored in a geospatially-indexed database. Machining learning services can be used to process data to identify features of interest.

Server 202 is shown to be connected to a series of further servers indicated by the hexagons, which also may be implemented on a computer or computing system configured as a server. For the purpose of the environmental event monitoring described here, these further servers are back-end servers. These back-end servers may take the form of microservers as is known in the art. The back end servers may serve environmental data from ground-based sources such as rainfall measurements, temperature measurements, wind-speed and others. Additionally or alternatively the back end servers may serve information from air and space-based platforms.

FIG. 2 shows a number of back end servers by way of example. A first group of back end servers are shown in box 204 which may communicate with the front end server 202 either directly or via one or more others. Weather service 204a may be any well-known type that uses not only ground-based data but also data obtained from air or space platforms. Machine learning server 204b may ingest environmental data from various other servers and operate as is known in the art for example to interpret what the data represents. This may include interpretation of image data to identify water or fire, or interpreting data from multiple sources such as temperature, rainfall and others to predict an event, all based on learning from previous interpretations.

A geospatial algorithm server 204c may be used to perform a number of functions including geolocating additional data in operation 109. Thus the geolocation of data may be performed by a third party server in some implementations of the methods and systems described here. From this it will be clear that the servers 204 and 206 to be described below may communicate with each other as well as with the front end server 202.

A ground sensor server 204d may serve a variety of ground-based sensor data including but not limited to rainfall, soil moisture, temperature and others.

A real-time streaming server 204e may serve data from any number of sources including but not limited to news feeds. Further, a real time streaming server may be used to provide any of the kinds of environmental data described here. For example, any of the other servers mentioned here may provide data on an off-line basis, such as weather data where is it possible to consult a server to discover what the weather was like at a certain place and date, but not necessarily in real time.

Therefore real-time streamed data from a real time streaming service may for example display a current river gauge flow number or a web cam image but not actually store it for very long if at all. Therefore in the methods and systems described here real-time data may be collected regularly and stored in the database 220. Algorithms may be used for that collection. For example, the program (or “service”) that collects river gauge information may be specific to collecting that type of data. In general in the methods and systems described here real time data may be ingested and/or translated in different types and/or formats and stored it in the database 220 in a common format.

A SNS (Social Networking Service) data server 204f may serve data from any number of sources including but not limited to news feeds, social media posts, on-line images, chat groups, etc., Server 204f may perform functions on SNS data such as crawling, retrieving and processing data from subscription sources, and others as known in the art to obtain potentially relevant data.

One or more of the back end servers 204a-f may be a source of first data as mentioned with reference to FIG. 1. One or more of the back end servers 204a-f may be a source of additional data as mentioned with reference to FIG. 1.

It will be appreciated that the functions of some of the servers 204 and 206 may be provided in other ways. For example servers are described as providing services that do not necessarily require a server. These services may be functionalities, apps, macros, or programs that can be provided by a server or by other means.

An important aspect of some of the methods and systems described here is services such as AI algorithms are able to interact with data collected automatically, for example through the use of servers. Servers such as server 202 can also provide a user interface for analysts and others to view, interact, and interpret the data as needed in order to generate insights into the environmental event and ultimately to determine the extent and local severity of the event.

FIG. 2 also includes a satellite 210 being one of a constellation which downlinks imagery, or image data, and may serve that content via a group of one or more ground-based servers 206 which are also back-end servers for the monitoring of environmental events as described here. Back end servers that may be associated with a constellation of satellites or airborne platforms may include an imagery archive 206a, and a Geographic Information System “GIS” map server 206b. The imagery may be processed by a variety of interchangeable functions to produce and serve analytics ready data (ARD) in sever 206c and leverage auxiliary data from a data lake based on the solution needs. Data lake content includes, but is not limited to, digital elevation maps, structural details, and weather information, and is served from server 206d.

A database 208 (or series of databases) may hold customer specific data or event specific data that is generated a priori or as part of an analysis. The database 208 may be in the form of a relational database such as PostgreSQL or other suitable format, which enables geospatial map visualizations.

In a specific example of how the various data sources shown in FIG. 2 may be used, an example of first data collected before activation of an event is river gauge data from all over the world that may be regularly ingested into the system before activation. It is useful to create a baseline and to help determine when to activate, although it would typically continue to be collected after activation, for example to monitor for events other than an activated event. Certain data collected before activation is data that is useful for predicting environmental events and for creating a baseline, whereas data collected after activation is collected on a much more frequent basis and is used for tracking the progress of the event and for creating and updating the flood model. Some of the data sources may be the same both before and after activation (e.g., river gauge, weather data, and possibly satellite data) but collected more frequently before activation. The criteria for collection of first and additional data may depend on the usefulness of the data in predicting or reliably alerting the occurrence of an event. Thus other data sources (such as social media data) require more analysis and as such it may not be efficient to collect it before the event is activated and an area of interest identified.

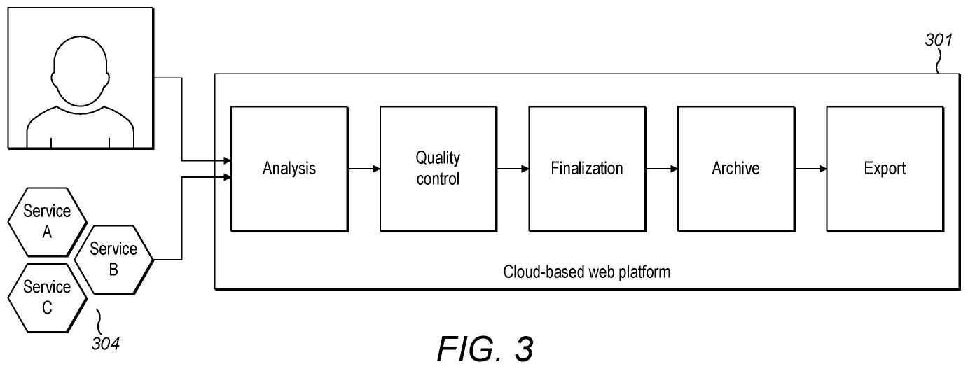

FIG. 3 is a schematic diagram of a process that may be implemented in the front end server 202 to interoperably allow automated ingestion and use of data from back end servers. The back end servers are indicated by the hexagons 304 which may for example comprise any of the servers described with reference to FIG. 2 or any other back end servers. A cloud based web platform, for example implemented in front end server 202, may perform operations on data received from back end servers to achieve the estimation of severity described with reference to FIG. 1. Thus the operations performed on received data may include any of analysis to determine local severity of event, quality control for example to determine reliability of analysis, finalization, archiving in the database 220, and exporting severity estimates, for example to an end user. These operations may be performed automatically. Alternatively some of these operations may be performed manually.

Due to the archived information, events may be revisited based on new data gathering or reanalysis needs. This persists and version controls the content required for analysis of these time-dependent events.

The systems and methods described here may provide critical information relating to environmental events to a variety of end users. One example of an end user of a method or system described here is an operator of emergency services who may use the system to ascertain where to direct resources. An end user may be able to use the front end interface to obtain information relating to specific locations within the extent of the event or the area identified at operation 102.

As mentioned above, methods and systems described here may be used to monitor various kinds of environmental event. In the following a specific example of a flood will be described.

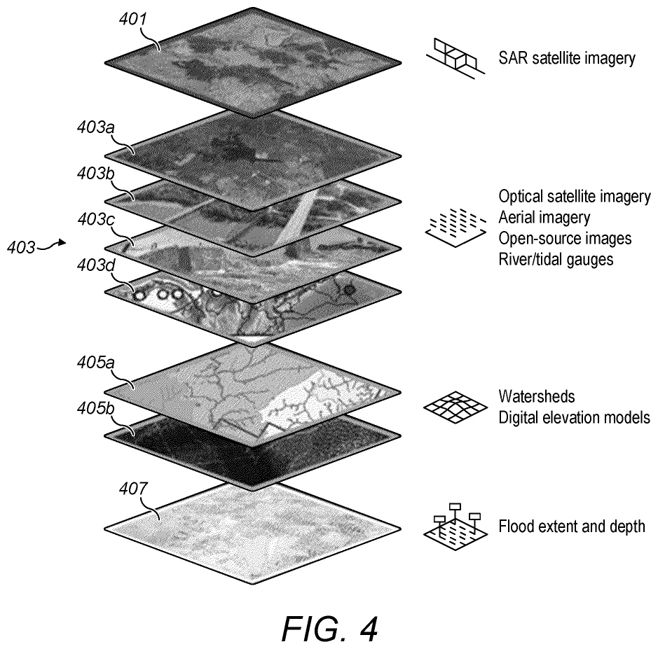

FIG. 4 is a schematic diagram showing a method of flood monitoring. This example method begins with collecting first environmental data which in this example is SAR satellite image data indicated at 401. The data may be inspected, either on the satellite or on the ground, to identify an environmental event. In general satellites may be used to monitor a variety of environmental events. We assume here that a flood is identified in the satellite image data.

SAR is an active technology that sends out radar signals and receives the echoes to form the image. This is in comparison to optical satellite technologies that are passive and rely on existing light (like a camera). SAR has the advantage of being able to image during the day or night, and also through clouds and other adverse weather that is impenetrable for optical satellites. Using SAR imagery to monitor floods can provide much more frequent monitoring of flooded areas, since optical satellites cannot image at night, and often are blocked from imaging the flooded area at the most critical times by the very weather system that is causing the flooding.

It may be possible to perform operation 102, identification of an area on Earth, from the SAR image data 401. Otherwise additional information may be used to identify the area such as a digital elevation model that will indicate low-lying areas prone to flooding.

It is assumed in FIG. 4 that an identified event has been determined to meet the one or more criteria mentioned with reference to operation 105. The event is then monitored at operation 107 by collecting additional data 403, for example as described with reference to operation 107. This may comprise additional SAR satellite imagery, optical satellite imagery 403a, aerial imagery 403b, open source images 403c such as may be obtained from social media, and river/tidal gauge information 403d shown in FIG. 4 as points on a map.

Optical imagery 403a and aerial imagery 403b can be used to augment the SAR imagery, and open source images 403c along with data from other sensors such as river and tidal gauges 403d can be used to augment the data regarding the flood.

Some of this additional data may need to be geolocated as indicated at operation 109 and subject to a decision as to its relevance at operation 111. Relevant additional data 403 is tagged as indicated at operation 115.

The tagged data 403 may be used to estimate the severity of an event at locations within the identified area corresponding to the event, or notification.

The determination of severity may use non-real time geographically indexed data as mentioned above. Thus an optional operation in FIG. 1, not illustrated, is to obtain non-real time data and use this in operation 117. The non-real time data may not be stored and tagged in the database 220. Examples include but are not limited to geographically indexed data such as watershed data 405a and digital elevation models (DEMs) 405b. These can then be combined with the flood data in order to create a model 407 of the extent and depth of the flood. In this example the depth represents the severity and from the model over the extent of the flood the severity at locations within the identified area, or extent of the flood (which may be an area within the identified area), is estimated.

It should be noted here that a watershed is an area which all drains into a common point. For example, the watershed of a river is all the land where rainfall on that land would end up in that particular river. Therefore in some implementations of the methods described here the identified area may comprise a watershed. A DEM is usually simply a digital elevation model of the land, and whilst it may be used to determine the boundaries of a watershed it may not contain sufficient information for watersheds to be identified. Watershed information is particularly useful, for example for determining whether rainfall data is relevant or not for flooding of a particular river. If the rainfall does not “fall” within the watershed of that river, it will not contribute to the flooding and as such likely does not need to be tagged. The model 407 can then be used to evaluate whether there is any impact of the environmental event on both man-made infrastructure such as buildings, and natural features such as rivers and forests. Combining the data from multiple sources combined with frequent satellite imagery allows for monitoring the flood in near real time.

The model may be used to predict the progress of the event and the additional environmental information collected at operation 107 may be used to update the model in real time as the event progresses.

An output of any of the methods described here may be actionable data, for example data confirming the depth of a flood at a particular building. The determination of the severity of the event at different locations may be used to prioritize some locations over others, so that resources responding to the event may be properly directed. In addition this type of information would be invaluable for example to governments of all levels, search and rescue organizations, insurance companies and other for helping the victims of the environmental events and for rebuilding after the event.

A method as described here may enable the severity of an event at one location to be determined very quickly from data relating to another location within the identified area. For example, as will be described further below, information on the depth of flooding of a particular building that may be obtained from a photograph posted on social media may be used together with a DEM to determine the depth of flooding at other buildings. One social media photograph showing shallow water at one building may be sufficient to determine that another building on lower ground is likely to be more severely flooded, whereby resources may be directed to the severely flooded building more quickly than is currently possible.

In the example of FIG. 4, the SAR data 401 and other geo-located data 403 including data from Earth based sources are combined with historical data, e.g. non-real time data relating to the terrain at the identified area to estimate the geographical extent of the event and the severity of the event at locations within the geographical extent. This can be done in near real time so that the extent and severity of the event can be monitored in real time. As a result of determining not only the extent of an event but also the localised severity, it is possible to determine not only whether a location was affected by the event but also how severely it was affected.

The determination of the severity of the event may for example comprise determining the height of damage caused by the event in relation to one or more structures on Earth. This may be determined from images and/or sensor data comprised in the geo-located data.

The determination of the extent and severity of the event may comprise comparing information derived from the additional data with the non-real time data. For example the additional data obtained in real time may be used to determine a current state of the event, for example showing areas of trees destroyed, area covered by water, or other features, and this may be compared with historical records to determine the severity of damage caused by the event.

In the example of FIG. 4, an event such as a flood may first be identified from the SAR image data and “activated”. In any of the methods described here, before or after the activation at operation 107, additional environmental data, for example geolocated social networking service “SNS” points and their attributes may be used to verify that the event occurred. These may for example include images of the event or areas or structures affected by the event.

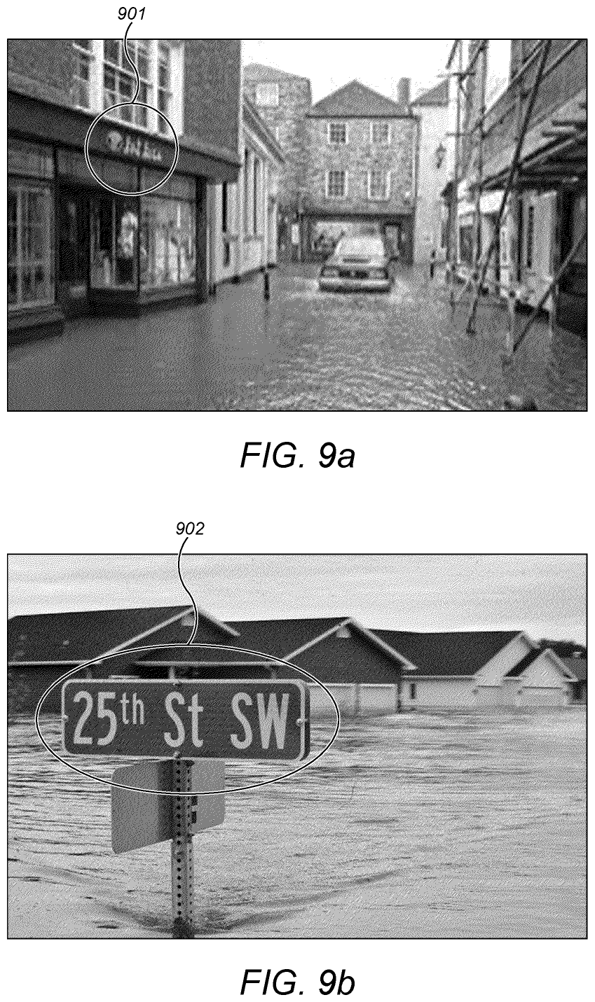

To take the example of a flood described further with reference to FIG. 9, water depths can be estimated from SNS images, with corresponding confidence levels. Water depths can be estimated using the street view from when no flooding was present combined with corresponding measurements during a flood.

The aggregation of data may use known tools. For example a suitable app such as Floodtags may be used to aggregate flood related tweets based on geography. This may be combined with historical data such as a DEM as mentioned above or a digital terrain map “DTM” to generate a flood depth map. The aggregation of data may include ranking of SNS sources and other sources of geo-located data by importance.

The terms DEM and DTM are used interchangeably in the art. DEM is used here to refer to a map that contains elevation information, e.g. height above sea level, of the mapped terrain. A DEM may contain additional information. A DTM may be a “bare earth enforced” model. In other words it may ignore surface structures, but may contain elevation information. Further a DTM may contain information not contained in a DEM, for example it may take account of the direction of flow of water. The methods described here may use DEM or DTM information as appropriate.

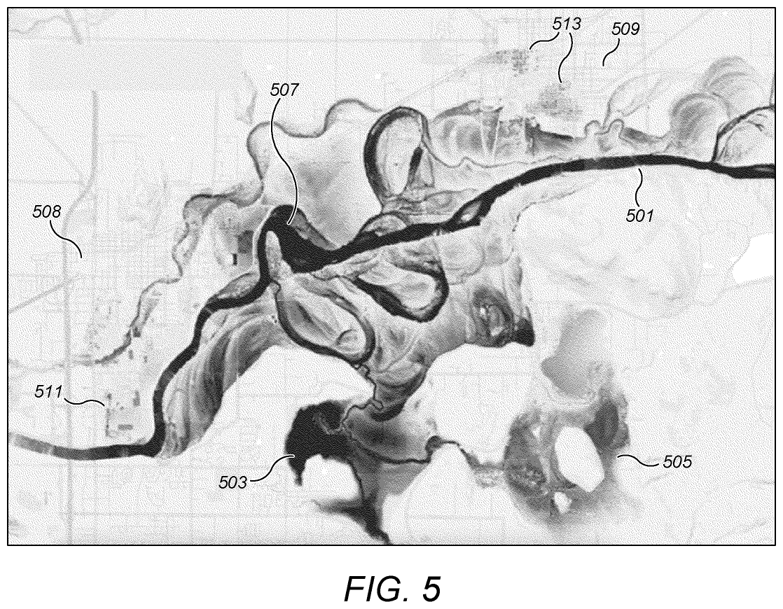

FIG. 5 is an image showing the extent of a flood affecting two small towns in Washington State, USA. In addition, the image provides an indication of the severity of flooding for buildings that are within the flood extent, with the severity determined by a method as described here. The figure is a composite of a SAR image combined with map information of an area that was subjected to a major environmental event, in this case an extensive flood occurring as a result of a major series of serious storms in November of 2021. An image of the kind shown in FIG. 5 may be formed using historical data relating to coverage of land by buildings. For example, building footprints may be obtained from the Federal Emergency Management Agency (FEMA) in the US, or from Microsoft Canadian Building Footprints. Other sources of building footprint data and other layers could also be used. In the image a river 501 is shown along with flooded areas such as 503, 505 and 507. Two urban areas are shown at 508 and 509. Monitoring of this environmental event was activated on November 11^{th} with the first satellite image acquisition occurring on November 13^{th} as the flood was approaching its peak. The last image acquisition was taken on November 18^{th} as the flood was receding and the final analysis was completed on November 19^{th}. This shows the speed with which these types of environmental events can occur and an example of the corresponding speed with which the monitoring system needs to be able to react and to collect the relevant data.

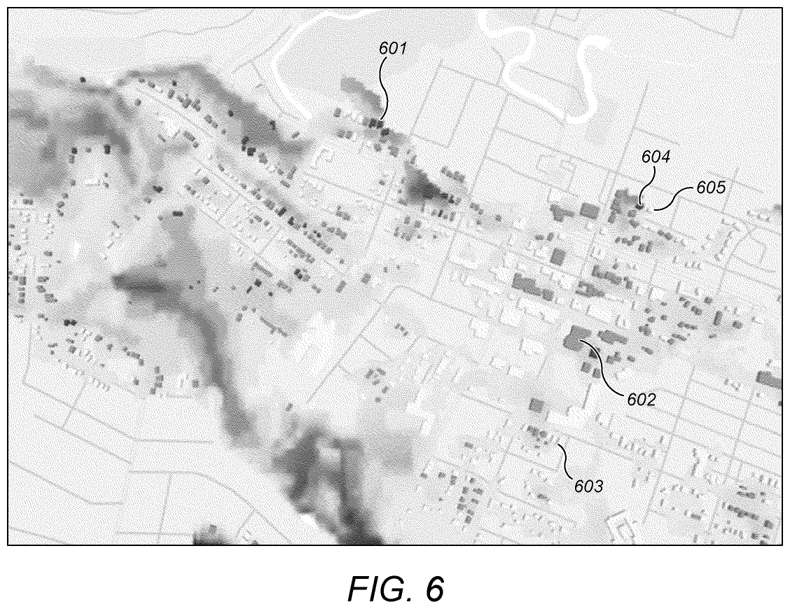

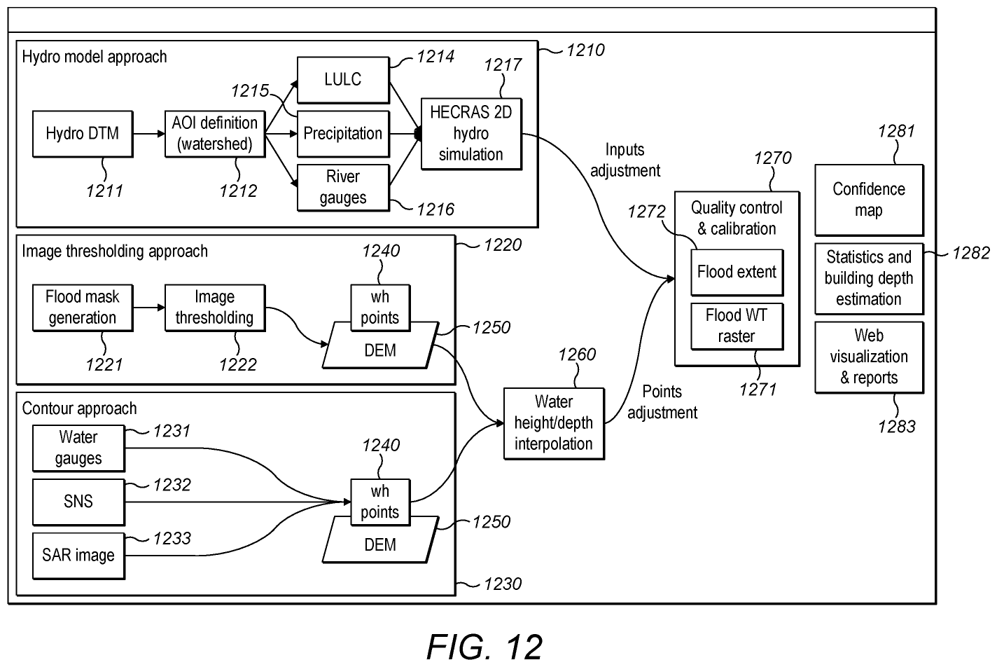

The system can provide information on the flood extent and the impact on infrastructure. In an example, the height of water is determined based on flood model developed using various sources of data as described with reference to FIG. 2 and by the combination of processes described in more detail below with reference to FIG. 12. In an example, social media information and news feeds can be used to calibrate and further refine the flood model. For the environmental event that caused the flooding in FIGS. 5 and 6, a total of 164 SNS points were collected, of which 96 were used for the analysis. In an example the environmental monitoring system as disclosed can provide a highly accurate model of the flood extent and the height of the water that was previously not obtainable by prior art methods. Knowing an accurate height of the water, flood depths can then be determined by using a digital terrain model and/or pre-flood data (e.g., images or other data) that can provide accurate heights for the underlying terrain. The flood depth of a given point within the flood extent may then be calculated by subtracting the height of the terrain from the height of the water for every point within the flood extent.

It can be seen from FIG. 5 that some of the areas within the urban setting have been flooded, such as at 511 and 513. Using the accurate flood depth information determined above, the depth of flooding for each building within the flooded areas can be determined based on the height of water at a building location. The severity of flooding for each building can be determined and, in this image, represented visually by shading in the flooded buildings with the darkness of shading indicating the depth to which the buildings have been flooded. In this image, there have been a total of 2,998 buildings flooded, with 1,643 flooded with a relatively low depth of water, 1,116 have been flooded with a medium depth of water, and 239 have been flooded with a high depth of water.

FIG. 6 is another image of a flood in a different urban area, this one located in British Columbia, Canada. Although separated by several hundred kilometers and an international boundary in between, the two areas shown in FIGS. 5 and 6 were caused by the same widespread environmental event that comprised a series of severe storms that brought very high amounts of precipitation to the area. In this example, data showing high levels of rainfall and images showing flooding generated a notification, corresponding to step 102 in FIG. 1. Areas of interest within the extent of environmental event in both Washington State and the Province of British Columbia were identified according to step 103 by using watershed information as well as administrative boundaries. Since there were to be quite a few urban areas impacted by the environmental event (step 105), monitoring of the environmental event was activated, and collection of additional environmental data (step 107) was started.

In FIG. 6, flood extents (areas) and impacted (flooded) buildings are identified. As in FIG. 5, the severity of flooding for individual buildings is shown. The most impacted buildings are shown with darker shading and lighter shading showing less-impacted buildings. For example, the three buildings at 601 are more darkly shaded and have been flooded with a higher severity (greater flood depth) than the building at 602, which has been flooded with moderate severity, and buildings at 603 have been flooded with relatively lower severity. Note the ability of the model to distinguish with a very fine granularity the difference between a building 604 that has been impacted with a high severity flooding and a building 605 right next door where the severity of the flooding was relatively low. In this image, there have been a total of 973 buildings flooded, with 539 flooded with a relatively low depth of water, 377 have been flooded with a medium depth of water, and 57 have been flooded with a high depth of water. Buildings that have not been impacted by any flooding are not shown in this image. The unprecedented ability of the monitoring system to accurately determine severity of flooding down to the building level and below makes the results very useful for a number of purposes, such as for search and rescue, directing of recovery resources, and estimating of damages by governments, home owners, insurance companies, financial services companies, banks, etc.

Data for various areas can be combined to provide an overall estimate of severity due to a particular environmental event. For example, the environment event that caused the flooding in FIGS. 5 and 6 was determined through the monitoring of the environmental event to have caused flooding with a total flood extent of just under 5,000 km². A total of 10,012 buildings were impacted on both sides of the Canada/USA border, with an average inundation at building level of 0.6 m.

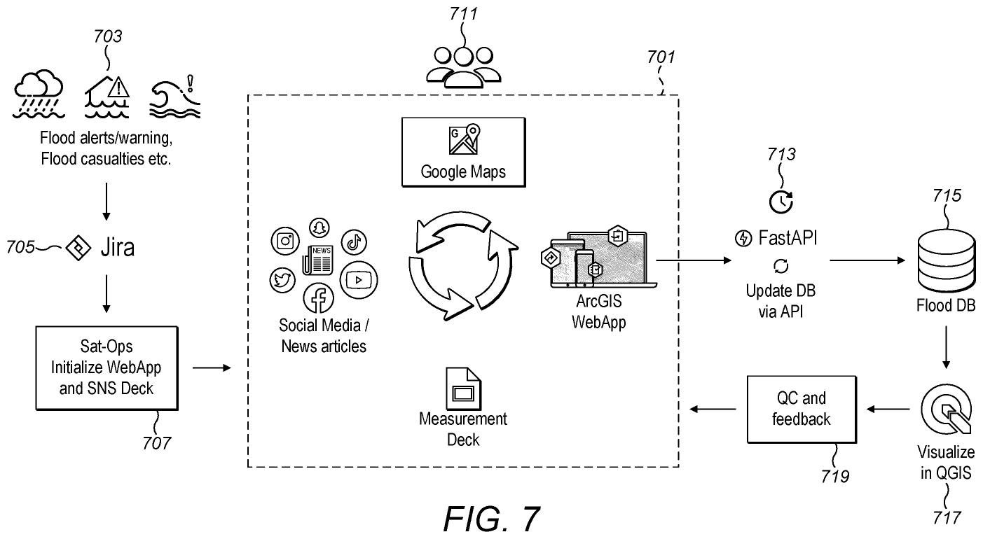

FIG. 7 is a schematic diagram illustrating how additional data may be processed. More particularly the flow of FIG. 7 may be used to process additional data collected in response to activation of an event for the estimation in operation 117, for example the creation of a model of the extent and severity of the event. Further, using the same flow, the additional data may be used to augment and calibrate the model or otherwise refine the model as additional data is collected and the event progresses.

Thus, in order to create the model or to augment and calibrate the model in the system or method, external information is processed into the database and, if needed, geographically indexed, analyzed and added to an event database.

FIG. 7 shows an example of the system used for flood monitoring. First a notification 703, for example derived from first environmental data (operation 101 in FIG. 1) is received and brought into a work management system 705. In an example, the known work management system Jira, which is a commercially-available system originally used for tracking bugs and issues, can be used. The work management system 705 may be used to determine whether the event meets the predetermined criteria (operation 105). Processes 707 are the initiated once an environmental event is identified and activated to collect additional environmental data (operation 107). Processes 707 can include tasking satellites to obtain high resolution imagery at frequent intervals, initializing a web-based system for inputting, analyzing, and viewing a geospatially indexed database, and initializing a SNS (Social Networking Service) deck for this event for collecting social media and other online information.

Viewing of the geospatially indexed database could be done for example using a known GIS system such as ArcGIS. In addition, this could be done online from any location using the ArcGIS WebApp. Other data used includes data from Google Maps, news articles, and analyzed information is put into a measurement deck. External services 711 provided by teams of analysts or artificial intelligence “AI” can analyze and process the data according to the flow indicated by box 701. A constant flow is shown to take place comprising taking in data from various sources such as the servers described here, analyzing the data automatically or manually, and updating the database 715 and the model 407. The flow indicated at 701 may include operations 107-117 of FIG. 1 and some or all of the stages indicated by box 301 in FIG. 3.

A geographically indexed database 715 is updated using an API (Applications Programming Interface) 713. An example of a commercially available API is FastAPI, a modern, fast (high-performance), web framework for building APIs with Python. The results can be visualized with a GIS visualizing program 717 such as QGIS in order to provided feedback 719 into the system 701. Quality control, either automated or manual or a combination of both, can be part of the feedback 719.

The workflow may continue on a near real-time basis and can provide information with a high degree of temporal and special accuracy and resolution.

As already mentioned, some of the methods described here may be used to model an event in near real time and/or to predict its progress. This is particularly useful with events of a transitory nature such as floods.

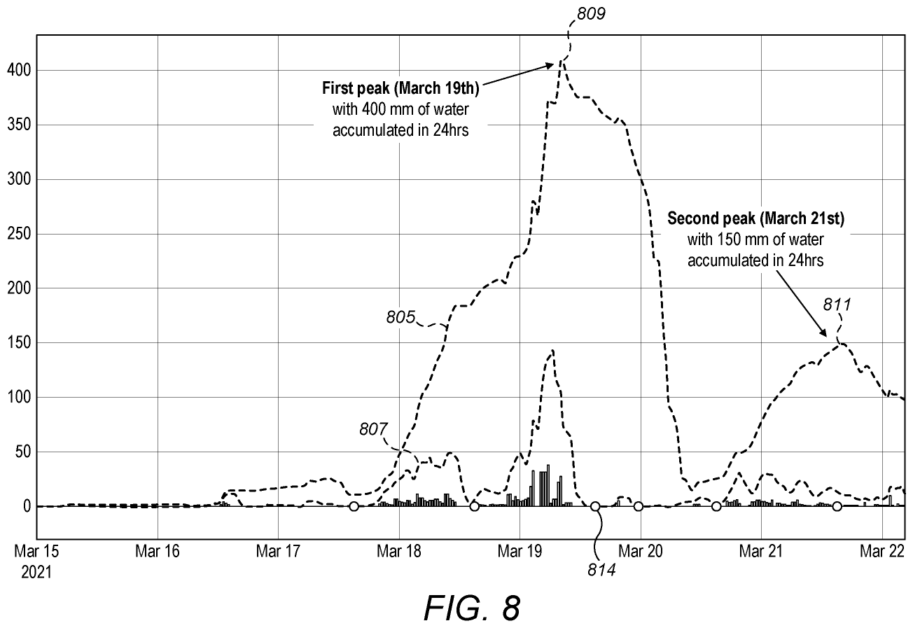

FIG. 8 shows an example of a precipitation timeline between Mar. 15, 2021 and into Mar. 22, 2021 for an environmental event, in this case a flood, in Port Macquarie, Australia that was monitored using a method and system as described here.

Using weather data, the 24 hour accumulation precipitation data (mm) was plotted and is represented by line 805. The 3 hour accumulation precipitation data (mm) is represented by line 807. Histograms 813 represent the precipitation data in mm/hour. After the heavy rainfall indicated by the histograms in the first half of March 19^{th}, a first peak 809 in line 805 occurs with an accumulation of just over 400 mm of precipitation in the previous 24 hours. This provides a good indication of where in the timeline peak flood may be occurring. A second smaller peak 811 occurs on March 21^{st} with 150 mm of water accumulation in the previous 24 hours. The dots along the x-axis indicate the points in time at which SAR satellite images are taken of the areas during the environmental event. Six points are shown. As can be seen, the point indicated by 814 is close to the first peak 809 and the SAR satellite image taken at that point in time was likely able to capture the flood at close to its peak level. FIG. 8 shows the benefit of being able to collect additional data such as image data with relatively high frequency during the course of an environmental event such as a flood.

Traditionally, a large SAR satellite that is a single asset or may be part of a small constellation, for example of three satellites or less, may only be able to revisit a given point on Earth to take another image once every couple of weeks or so.

A constellation of small SAR satellites makes much more frequent repeats possible. In this example, points are taken with a constellation of five or more small SAR satellites. From the six points shown, it can be seen that a first SAR image of the area was taken on May 17^{th} before the rainfall amounts really started ramping up, thereby enabling a baseline datapoint from before any flooding might have occurred. From May 17^{th} onwards, one image is taken approximately once every 24 hours, with an extra image taken near midnight on March 19^{th} that would have provided good data around the peak flood point. In this example, images are taken at least once per day. In alternative examples, with a sufficiently large constellation of satellites, images could be taken even more frequently. For example, once every 12 hours, once every six hours, or once every three hours or less. The more frequent the repeats the better the temporal resolution. Larger constellations such as ten satellites or more, twenty satellites or more, or fifty satellites or more can help to enable these frequent repeat rates to provide unparalleled and previously impossible temporal resolution for Earth monitoring data.

Data such as Social Networking Service (SNS) points can be used to calibrate models and to refine the dataset. In the example of flood monitoring, SNS points can be used to confirm not only the presence of flooding in precise locations, but also the severity of the flooding. FIG. 9a and FIG. 9b show examples of two flooded scenes that could be used for helping to calibrate a flood model in this area. First of all, it is clear from the photos that an environmental event, in this case flooding, is occurring in these locations, and this information in and of itself would be of use within the geospatially-indexed database used to monitor the flood. However, SNS data is often not geolocated, so an important step is to geolocate the images. This can be done using clues such as the store sign 901 in FIG. 9a, and the flooded street sign 902 in FIG. 9b. Clues such as these can then be used to search for the location in a suitable reference source such as on Google maps. Being able to geolocate SNS data opens up the possibility of using a much wider range of SNS imagery and can provide much more data on the event being monitored, compared to only being able to use already-geolocated SNS data.

Photos such as those shown in FIG. 9 may be the origin of a notification that a flood has occurred. Additional corroborating information may be collected before the event is activated, and operation 107 commences. The information from photos, which may for example have been collected from social media sources, may comprise part of the additional information used to determine the severity of the event at locations within the area of the event at operation 117.

As noted above, the estimation of the severity of the event may comprise combining the non-real time data with additional environmental data collected in real time to create a model of the extent and severity of the event. To take the example of a flood, the real time data may comprise photos such as those shown in FIG. 9. FIG. 9b shows a street sign that has been flooded to near the signs themselves, and garage doors flooded to near the top of their height. From this information the depth of the water at that location may be estimated. This information may be combined with non-real time data such as a DTM to determine the likely depth of the flood at other locations. A lower lying building is likely to be more severely flooded and warrant priority attention from emergency services for example to evacuate the flooded residents. From this example it can be seen that an initial model can be created with limited real time information.

The following table is an example of information obtained by monitoring a flood by a method according to FIG. 1.

Impact Table: Prioritization based on
impacted buildings and observed depth

| | | | Flooding | | Estimated |
|---|---|---|---|---|---|
| | | | Observed | Estimated | Observed |
| | | Flooding | in Open | # of | Flood |
| | | Observed | Source | Buildings | Depth |
| CITIES | AOI | in SAR | Imagery | Flooded | (cm) |
| Somerville | 1 | YES | YES | 100+ | 50+ |
| Manville, NJ | 1 | YES | YES | 100+ | 50+ |
| Bound Brook, NJ | 1 | YES | YES | 100+ | 50+ |
| South Brook, NJ | 1 | YES | YES | 100+ | 50+ |
| Raritain, NJ | 1 | YES | YES | 100+ | 50+ |
| New Brunswick, | 1 | YES | YES | 100+ | 50+ |
| NJ | | | | | |
| Piscataway, NJ | 1 | N/A | YES | 1-10 | 10-50 |

The collection of additional environmental information at operation 107 will continue after the initial creation of the model. In the example of FIG. 9, geolocated data such as that obtained from photos can be used to check the flood model to ensure that the flood depths are being accurately estimated. As with the initial creation of the model, an estimate for the depth of water can be determined based on the picture and that depth assigned to the point, which can be used to further calibrate the flood model.

It will be appreciated from the foregoing that the determination of the severity of the event may comprise determining the height of damage caused by the event in relation to one or more structures on Earth. In the case of other kinds of event the height of damage might be estimated from flame height, blackening and other indications that may depend on the nature of the event being monitored.

In the foregoing the principle example of non-real time data, e.g. data obtained prior to the event, is the DEM, but other kinds of non-real time data may be used for flooding and other kinds of environmental event.

To take the example of a forest fire, the event may be modelled using non-real time information from prior to the event such as records of extent of tree and building coverage. A single photo of a fire at a particular location may be combined with other environmental data such as wind speed to model the event, its severity at particular locations, and its likely progress. The model may be used as a first indication of where resources should be directed, and this may be updated using additional environmental data as the event progresses.

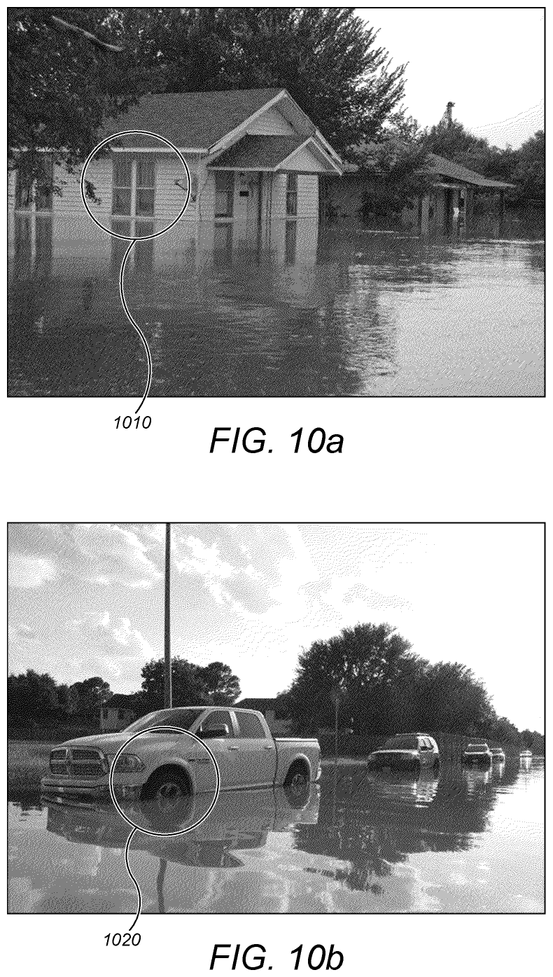

FIG. 10a shows an example of a photo of a building in a flood zone that might have been obtained from social media for example and may be geolocated. For example, the building could be geolocated from a satellite view of the building from before the flood (e.g., from Google Maps or some other suitable source). A height of water can be estimated from the picture in FIG. 10a and assigned to the geolocated point. The height of the water can be estimated for example by looking at the location of the water relative to the visible windows 1010 of the building. Water heights can be determined in a variety of ways from images. In another example, heights of water can be estimated from social media and news images by looking at the height of the water relative to vehicles. In FIG. 10b, a pick-up truck wheel 1020 visible in the image shows water flooded up to approximately the half way point of the wheel. A relatively accurate water depth can be estimated by knowing the average height of a wheel for a pick-up truck and can be used to further calibrate the water depth model by entering the water depth estimation at the geolocated location of the truck.

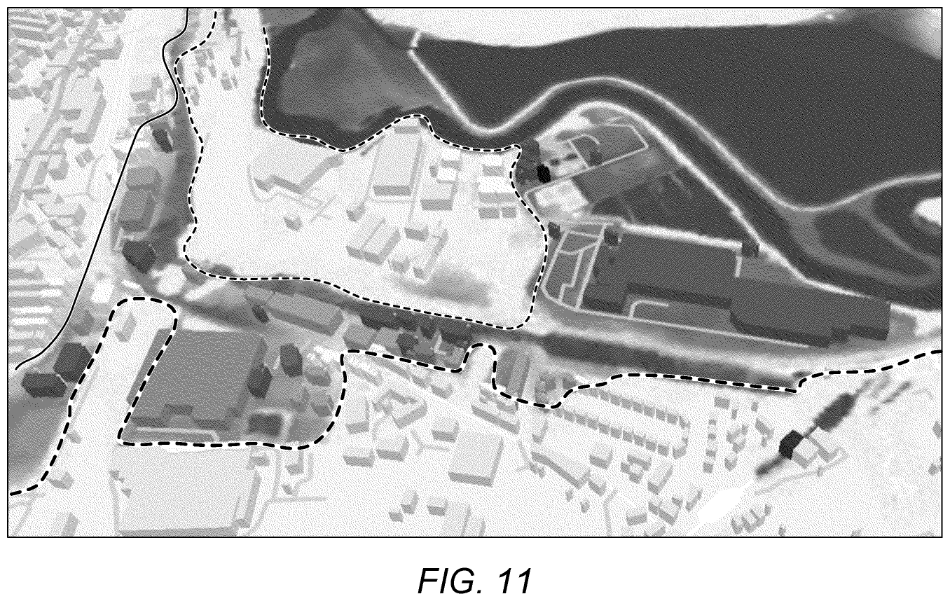

FIG. 11 is a two dimensional image of a flood showing how the extent of an environmental event such as a flood may be determined from a model. A dotted line is drawn around the extent of the flood and any buildings within that extent that have a geolocation below the level of the water can be considered to be impacted, e.g. flooded. Buildings that have geolocated points with elevations that are further below the water can be considered to be medium severity, and buildings that are even further below the surface of the flood water can be considered to have high severity. In FIG. 11, buildings with darker shading represent higher severity, medium shading medium severity, and more lightly shaded buildings low severity. Buildings that are not within the flood extent are considered to have not been impacted and are not shaded.

FIG. 12 shows a number of processes that have been successfully tested for monitoring flooding and modelling its extent and progress. These processes may be modified for use in monitoring other environmental events.

The processes shown in FIG. 12 involve obtaining non-real time data relating to the event and using the non-real time data in the estimation of the severity of the event at locations within the identified area. The determination of the extent and severity of the event in these examples comprises combining non-real time data with additional environmental data collected in real time to create a model of the extent and severity of the event.

The different processes are also referred to in the following as “approaches” since they approach the task of modelling an event in different ways but may be combined to achieve a result with a higher confidence level than is obtained by any of the individual approaches.

Box 1210 in FIG. 12 indicates a hydro model approach. Box 1220 indicates an image thresholding approach. Box 1230 indicates a contour approach. In the image thresholding and contour approaches the real time data comprises image data and the non-real time data comprises elevation data relating to the identified area.

Any one or more of these may be used alone or in combination in the monitoring of an environmental event.

In the hydro model approach 1210, a hydro DTM 1211 as is known in the art, or other elevation data such as a DEM, may be used together with additional data such as real time environmental data to model a flood and its severity at locations within its extent. In the example of FIG. 12 additional data in the form of precipitation 1215 and river gauge 1216 data are indicated, together with land use/land cover “LULC” information 1214. River gauge data can for example provide information about how much water is flowing through the river at that point. The LULC and hydro DTM may be non-real time data. An AOI 1212 may be identified from watershed data as noted above. This data may be used to model the extent of the flood and severity at locations within the extent, for example by inputting the data input to a known software tool for flood modelling such as HEC-RAS 2D. As noted above, with one or preferably a few reliable estimates of the flood depth, together with historic elevation data, it is possible to estimate the depth of water for example over the whole of the AOI, for example at a resolution corresponding the DEM.

The image thresholding and contour approach both use live observations of the event to model its local severity and optionally also its extent. Visual observations, such as from images obtained on the ground or above ground, have been found to be particularly useful.

In the image thresholding approach 1220, water height or depth may be determined, possibly for a whole AOI, using only image data, for example SAR or other image data, and elevation information such as may be obtained from a DTM or DEM. After optionally generating a flood mask 1221 to define an AOI, an image such as a SAR image may be subject to a thresholding process 1222 in which pixels are categorised according to whether or not water is present in the area on earth corresponding to the pixel, for example using any known image analysis technique. It may then be determined whether the pixels indicate flooding, for example by comparing current images with previous images. The area represented by the pixels that indicate flooding will correspond to the extent of the flood, in other words the area may be used to estimate the extent of the flood. The area may further be used together with a DEM 1250 to determine the depth of the water, or height of the flood, at locations within the identified area, or the extent of the flood. For example, at the boundary of the flood extent the water depth will be zero, and the height of the flood water surface can be determined from the height of ground at the flood extent. Using this information, flood depths at any given point within the flood extent can be determined by subtracting the height of land at that point (obtained from a DEM) from the height of the water at that point. In another example, if an area of high ground appears flooded, the DEM may be used to infer that areas of lower ground are more deeply flooded. This information alone has been found to provide a useful estimation of the local severity of a flood within its extent.

In the contour approach, any information relating to water height or depth, together with elevation information, may be used to determine the extent of a flood and its local severity. A single piece of height or depth information, provided that it is reliable, may be sufficient to provide an initial estimate. The height or depth information may be obtained from any suitable source, many of which have been mentioned above. FIG. 12 indicates some sources, namely water gauges 1231 which may for example measure the height of the water in a river or a body of water, SNS data 1232 such as from photographs as discussed above, and image data 1233 such as from SAR. Any of these may be used to estimate water height and may be used in combination to increase confidence in an estimate, as is known in the art.

The use of the term “contour” is derived from mapping geographical areas in which contour lines are used to join geographical structures at the same elevation, for example height above sea level. Knowing the water height at one location, it may be assumed that the extent of the flood is bounded by geographical structures at the height of the water. In other words it may be assumed that an area bounded by a contour line at that height is flooded. Within that area the local depth or height of water may be estimated using an elevation model such as a DEM 1250 as described above.

It may be inferred from the above that an assumption is made that the water will be at the same level within the AOI. This may not be the case where the water is flowing relatively fast and therefore any of the methods as described here may take account of the flow rate, which may again be estimated from the additional data collected at operation 107, rather than assuming that the surface of the water is horizontal.

Each of the approaches 1210, 1220, 1230 may be used individually or in combination to model and monitor the progress of a flood. However any of them may be used in combination to provide a more accurate model, e.g. a model with a higher confidence level. A model obtained from one approach may be used to verify another. Tests have shown that the hydro modelling approach 1210 may be wrong in respects where the image thresholding or contour approach are more accurate.

Therefore FIG. 12 shows the results of all three approaches being subject to quality control and calibration 1270, from which the flood extent 1272 may be generated and a raster model 1271 of the water height (WT) may be generated. Any one or more of a confidence map 1281, statistics and building depth estimation 1282, and visualisation, for example web-based may also be generated, examples of which are shown in FIGS. 5, 6 and 11.

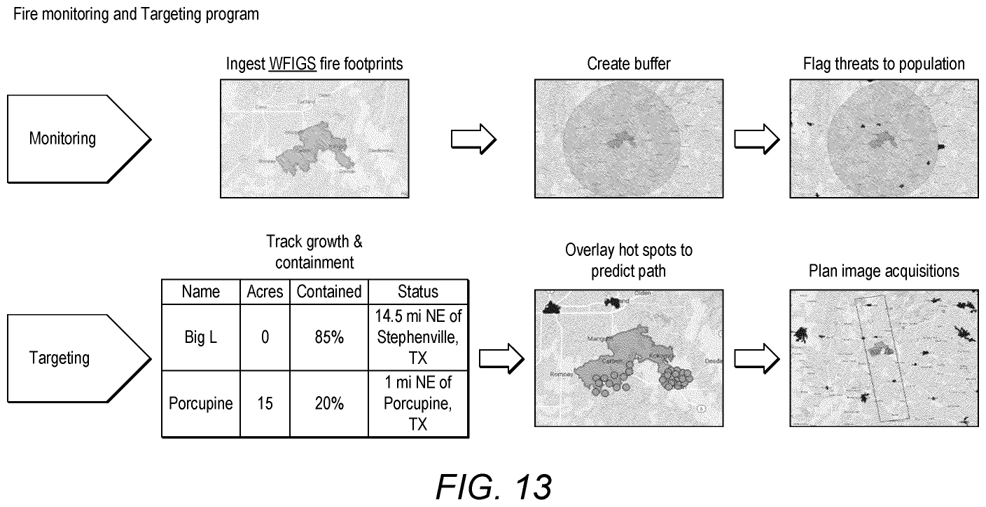

FIG. 13 shows how the principles of monitoring an environmental event may be applied to other events, in this case fires. In a monitoring mode, or phase, such as operation 101, first environmental data may be collected. FIG. 13 shows the example of Wildland Fire Interagency Geospatial Services (WFIGS) Group which provides geospatial data relating to fires. This data may be buffered, and analysed to identify a fire that meets criteria at operation 105, for example because it presents a threat to population.

An event that does present a threat to population, or meets other criteria, may then trigger a targeted phase or mode, corresponding to operation 107, where additional data is collected. FIG. 13 shows initial data relating to a fire that may be used to determine criteria for the collection of additional data. As with the example of flooding this may be collected from many of the sources described with reference to FIG. 2 for example. Information obtained in this way may be used to determine hotspots in an area affected by the fire and predict its likely path. In the example of a fire, local severity within the extent of the fire may be determined at different resolutions, down to single building level as described in relation to flooding.

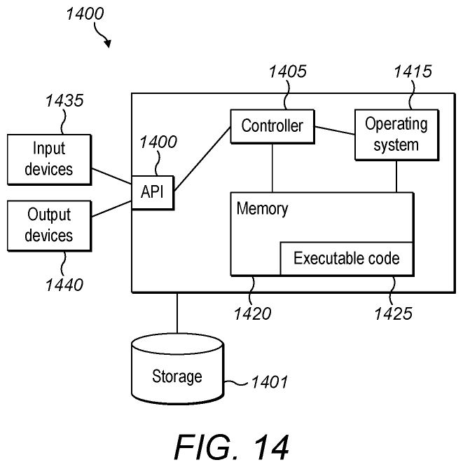

Reference is now made to FIG. 14 showing a block diagram of an exemplary computing system 1400 which may be used to implement any of the systems and methods described in the foregoing. Computing system 1400 may comprise a single computing device or components, and functions of system 1400 may be distributed across multiple computing devices. As noted in the foregoing a system is described here is likely to be distributed across multiple locations. Therefore a system as described in the foregoing may comprise multiple systems as shown in FIG. 14. Each of the servers described above may for example be implemented in a computing system as shown in FIG. 14. Computing system 1400 may include one or more controllers such as controller 1405 that may be, for example, a central processing unit processor (CPU), a chip or any suitable processor or computing or computational device, an operating system 1415, a memory 1420, storage 1401 which may for example contain database 220, input devices 1435 and output devices 1440.

One or more processors in one or more controllers such as controller 1405 may be configured to carry out any of the operations described above. For example, one or more processors within controller 1405 may be connected to memory 1420 storing software or instructions that, when executed by the one or more processors, cause the one or more processors to carry out the operations. Controller 1405 or a central processing unit within controller 1405 may be configured, for example, using instructions stored in memory 1420, to perform the operations shown in FIG. 1.

Operating system 1415 may be or may include any code segment designed and/or configured to perform tasks involving coordination, scheduling, arbitration, supervising, controlling or otherwise managing operation of computing system 1400, for example, scheduling execution of programs. Operating system 1415 may be a commercial operating system. Memory 1420 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long term memory unit, or other suitable memory units or storage units. In one embodiment, memory 1420 is a non-transitory processor-readable storage medium that stores instructions and the instructions are executed by controller 1405. Memory 1420 may be or may include a plurality of possibly different memory units.

Executable code 1425 may be any executable code, e.g., an application, a program, a process, task or script. Executable code 1425 may be executed by controller 1405 possibly under control of operating system 1415. Executable code 1425 may comprise code for selecting an offer to be served and calculating reward predictions according to some embodiments of the invention.

Storage 1401 may be or may include one or more storage components, for example, a hard disk drive, a solid-state drive, a Compact Disk (CD) drive, a CD-Recordable (CD-R) drive, a universal serial bus (USB) device or other suitable removable and/or fixed storage unit. Memory 1420 may be a non-volatile memory having the storage capacity of storage 1430. Accordingly, although shown as a separate component, storage 1430 may be embedded or included in memory 1420.

Input to and output from a computing system according to some embodiments of the invention may be via an API, such as API 1412 shown in FIG. 14. The API 1412 shown in FIG. 14 operates under the control of the controller 1205 executing instructions stored in memory 1420. on.

Input devices 1435 may be or may include a mouse, a keyboard, a touch screen or pad or any suitable input device. It will be recognized that any suitable number of input devices may be operatively connected to computing system 1400 as shown by block 1435.

Output devices 1440 may include one or more displays, speakers and/or any other suitable output devices.

Input devices 1435 and output devices 1440 are shown as providing input to the system 11400 via the API 1412 for the purpose of embodiments of the invention. For the performance of other functions carried out by system 1400, input devices 1435 and output devices 1440 may provide input to or receive output from other parts of the system 1400.

Some embodiments of the invention may include computer readable medium or an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, some embodiments of the invention may comprise a storage medium such as memory 1420, computer-executable instructions such as executable code 1425 and a controller such as controller 1405.

A system according to some embodiments of the invention may include components such as, but not limited to, a plurality of central processing units (CPU), e.g., similar to controller 1405, or any other suitable multi-purpose or specific processors or controllers, a plurality of input units, a plurality of output units, a plurality of memory units, and a plurality of storage units. An embodiment of system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

Some operations of the methods described herein may be performed by software in machine readable form e.g., in the form of a computer program comprising computer program code. Thus, some aspects of the invention provide a computer readable medium which when implemented in a computing system cause the system to perform some or all of the operations of any of the methods described herein. The computer readable medium may be in transitory or tangible (or non-transitory) form such as storage media include disks, thumb drives, memory cards etc. The software can be suitable for execution on a parallel processor or a serial processor such that the method operations may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The embodiments described above are largely automated. In some examples a user or operator of the system may manually instruct some operations of the method to be carried out.

In the described embodiments of the invention the system may be implemented as any form of a computing and/or electronic system as noted elsewhere herein. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The term “computing system” is used herein to refer to any device with processing capability such that it can execute instructions. Those skilled in the art will realise that such processing capabilities may be incorporated into many different devices and therefore the term “computing system” includes PCs, servers, smart mobile telephones, personal digital assistants and many other devices.

It will be understood that the benefits and advantages described above may relate to one embodiment or may relate to several embodiments. The embodiments are not limited to those that solve any or all of the stated problems or those that have any or all of the stated benefits and advantages.

Any reference to “an” item or “piece” refers to one or more of those items unless otherwise stated. The term “comprising” is used herein to mean including the method operations or elements identified, but that such operations or elements do not comprise an exclusive list and a method or apparatus may contain additional operations or elements.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

The order of the operations of the methods described herein is exemplary, but the operations may be carried out in any suitable order, or simultaneously where appropriate. Additionally, operations may be added or substituted in, or individual operations may be deleted from any of the methods without departing from the scope of the subject matter described herein. Aspects of any of the examples described above may be combined with aspects of any of the other examples described to form further examples.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A computer implemented method of monitoring one or more environmental events on earth comprising:
receiving a notification of an environmental event occurring, wherein the notification is derived from first environmental data;
identifying an area on Earth corresponding to the notification;
determining that the event meets one or more predetermined event criteria;
in response to the determination that the event meets one or more predetermined event criteria, monitoring the event by collecting additional environmental data;
determining that the additional environmental data is relevant to the event according to one or more relevance criteria;
in response to determining that the additional environmental data is relevant to the event, tagging the additional data to the event in a geographically indexed database; and
using the tagged data in the database to estimate the severity of the event at locations within the identified area.

2. The method of claim 1, wherein:
the identifying of the area comprises obtaining additional information in order to identify the area; and
the identifying of the area comprises identifying an area on Earth likely to be affected by the event.

3. (canceled)

4. The method of claim 1, wherein the collection of additional environmental data comprises collecting the first environmental data at a higher frequency than a frequency at which it is collected to derive the notification of an environmental event occurring.

5. The method of claim 1, wherein the collection of additional environmental data comprises collecting data from additional sources that are not comprised in the first environmental data.

6. The method of claim 5, wherein the additional sources not comprised in the first environmental data comprise social media sources.

7. The method of claim 1, wherein one or both of the first environmental data and the additional environmental data comprises social media data.

8. The method of claim 1, comprising obtaining non-real time data relating to the event and using the non-real time data in the estimation of the severity of the event at locations within the identified area.

9. The method of claim 8, wherein the estimation of the severity of the event comprises comparing information derived from the additional data with the non-real time data.

10. The method of claim 8, wherein the estimation comprises combining the non-real time data with additional environmental data collected in real time to create a model of the extent and severity of the event.

11. The method of claim 10, wherein the real time data comprises image data and the non-real time data comprises elevation data relating to the identified area.

12. The method of claim 11, wherein;
the event comprises a flood and the additional environmental data comprises pixel data; and
using the tagged data to estimate the severity of the event comprises:
analysing pixels in the image data to determine whether or not water is present in the area on earth corresponding to the pixel; and
using the pixel analysis in combination with area elevation data to determine the depth of the water at locations within the identified area.

13. The method of claim 10, wherein the event comprises a flood, the non-real time data comprises elevation data relating to the identified area and the real time data comprises water height data, and the method comprises:
using the elevation data to determine the extent of the flood by identifying structures at the water height, and
using the elevation data to determine the depth of the water at locations within the extent.

14. The method of claim 8, comprising continuing to monitor the event by collecting additional environmental data and updating the model using the additional environmental data.

15. The method of claim 1, wherein:
the additional environmental data comprises one or more images of the event; and
the method further comprises analysing the one or more images to determine the severity of the event.

16. (canceled)

17. The method of claim 1, wherein the determination of the severity of the event comprises determining the height of damage caused by the event in relation to one or more structures on Earth.

18. The method of claim 1, wherein;
one or both of the first environmental data and the additional environmental data comprises data obtained from a satellite in space;
the data obtained from a satellite in space comprises synthetic aperture radar data;
the satellite in space comprises a part of a constellation of five or more satellites, ten or more satellites, twenty or more satellites, or fifty or more satellites; and
the data obtained from a satellite in space comprises data obtained with a frequency of at least once every 12 hours, at least once every six hours, or at least once every three hours.

19.-21. (canceled)

22. The method of claim 1, wherein the locations comprise landmarks, buildings or other features within the identified area.

23. The method of claim 1, wherein:
the locations comprise areas within the identified area; and
the areas within the identified area are contiguous.

24. (canceled)

25. A computing system comprising one or more processors and memory, wherein the one or more processors are configured to implement a method as claimed in claim 1.

26. Computer readable medium comprising instructions which when implemented on one or more processors in a computing system cause the system to implement a method as claimed in claim 1.
